(19) United States
(12) Patent Application Publication
(10) Pub. No.: US 2013/0166040 A1
(43) Pub. Date: Jun. 27, 2013

(54) REAGENTS AND METHODS FOR PREPARING TEETH FOR IMPLANTATION

(71) Applicant: Thomas G.H. Diekwisch, Chicago, IL (US)

(72) Inventor: Thomas G.H. Diekwisch, Chicago, IL (US)

(73) Assignee: The Board of Trustee of the University of Illinois, Urbana, IL (US)

(21) Appl. No.: 13/805,845

(22) PCT Filed: Jun. 24, 2011
(86) PCT No.: PCT/US11/41801

§ 371 Date: Mar. 8, 2013

Related U.S. Application Data
(60) Provisional application No. 61/358,310, filed on Jun. 24, 2010.

(51) Int. Cl. A61C 8/02; A61C 8/00

(52) U.S. Cl. CPC A61C 8/0006; A61C 8/0009
USPC 623/23.57; 514/1.1; 424/94.63; 427/2.29

(57) ABSTRACT

The invention provides reagents and method for replacing teeth lost to periodontitis and other diseases and disorders resulting in tooth loss, and provides materials and methods that result in replacement or reimplanted teeth that have a higher rate of stable, long-term implantation status. In a first aspect, the invention provides an implantable tooth, comprising a natural or artificial animal tooth having a microporous tooth root surface, wherein said tooth root surface comprises a plurality of periodontal ligament progenitor cells coating all or a portion of the tooth root. In particular embodiments, the tooth is a natural tooth, especially a human tooth. In alternative embodiments, the tooth is an artificial tooth. In particular embodiments, the tooth comprises a periodontal ligament progenitor cell coating that further comprises one or a plurality of extracellular matrix proteins. In a second aspect, the ivnention provides kits for preparing an implantable tooth.

### CROSS-REFERENCE TO RELATED APPLICATIONS

This application claims priority to U.S. provisional patent application Ser. No. 61/358,310, filed Jun. 24, 2010, the entirety of which is incorporated by reference herein.

This invention was made with government support under Grant No. DE15045 awarded by the National Institutes of Health. The government has certain rights in the invention.

### BACKGROUND OF THE INVENTION

1. Field of the Invention

This invention provides reagents and methods for promoting reimplantation of teeth into animals, particularly humans. The invention provides naturally occurring and artificial teeth prepared by treatement with periodontal ligament progenitor cells for implantation and methods for performing reimplantation with these prepared teeth. Also provided are kits comprising reagents for preparing teeth with progenitor cell coatings.

2. Description of Related Art

Periodontal disease and tooth loss are a continuing problem despite overall improvement in dental health and treatment. Although tooth retention has greatly improved over the past few decades, a significant percentage of older Americans do not have functional dentitions and only 42.4% of the U.S. population aged 50 years and older have 21 or more natural teeth, representative of a functional dentition (Oliver & Brown, 1993, Periodontology 2000 2:117-127; Burt & Eklund, 1999, DENTISTRY, DENTAL PRACTICE, AND THE COMMUNITY, 5^{th} Ed., Philadelphia, Pa.: W.B. Saunders Co.). The 95% of Americans suffering from periodontal disease are now more than ever seeking cures for their ailments. During periodontitis, periodontal tissues are gradually destroyed by a series of inflammatory reactions that affect the gingiva, the fibrous attachment of the periodontal ligament, the root surface, and the alveolar bone of attachment. The consequences of severe periodontitis are increased tooth motility and ultimately tooth loss (Flores-de Jacoby and Diekwisch, 1990, “Periodontal Surgery,” in: Ketterl (ed.), PRACTICAL DENTISTRY, Vol. 4, 2nd edition. Munich: Urban & Schwarzenberg.).

Conservation and regeneration of periodontal tissues are the main goals of periodontal treatment (Melcher, 1970, Arch. Oral Biol. 15: 1183-1204; Melcher, 1976, J. Periodontol. 47: 256-260; Zander et al. 1976, J Periodontol 47: 261-6; Flores-de-Jacoby and Diekwisch, 1990, Id.). Until the 1980's, periodontal therapy had been based on scaling, root planing, curettage and periodontal flap surgery (Wisman, 1920, Brit Dent J 1: 293; Kirkland, 1931, J. Amer. Dent. Assn. 18: 1462; Ramfjord and Nissle, 1974, J. Clin. Periodontol. 45: 601; Lindhe, 1988, TEXTBOOK OF CLINICAL PERIODONTOLOGY, 2d ed., Munksgaard, Copenhagen; Flores-de-Jacoby and Diekwisch, 1990, Id.). Biologically, flap surgery and open curettage resemble scar-type healing without functional gains (Yukna, 1976, J. Periodontol. 47: 696-700; Caton and Nyman, 1980, J. Clin. Periodontol. 7: 212-223; Lindhe, 1988, Id.). In the pst twenty years, however, periodontal treatment has become one of the most advanced clinical disciplines, using biomimetic strategies including guided tissue regeneration with non-resorbable and resorbable membranes (such as Gore-Tex®), and guided bone regeneration (Osseoquest®).

Teeth lost to periodontitis and otherwise (such as trauma) are often replaced by implants. From a biological perspective, dental implants rely on the tolerance and functional coexistence of implant materials such as titanium metals in bones (Branemark, 1983, J. Prosthet. Dent. 50: 399). In the U.S., approximately 74 million adults are potential candidates for dental implants. However, the high cost of dental implants ($1,500-$4,000 per tooth, $25,000 for an entire jaw) limits access to care to affluent populations. Moreover, implant success is not guaranteed, and repeat implants in the same site become increasingly difficult. Implant success rates are between 85%-90% for 5-10 years (Misch 1999, CONTEMPORARY IMPLANT DENTISTRY, 2d ed., St. Louis: Mosby) and complications include nerve trauma, integration failure, sinus damage, inflammation in tissues surrounding the implant including bone, and implant fracture. While extremely successful commercially, dental implants are essentially foreign bodies tolerated within jaw bones. Implants also lack periodontal ligaments, which leads to an increase in failure rates due to increased stress on attachment tissues in cases of malocclusion and bruxism (Rangert et al. 1995, Intl. J. Oral Maxillofacial Implants 10: 326-34; reviewed by Nishimura et al. 1997, CDA Journal 25: 867-871).

Although reconstructing lost or diseased periodontal tissues, for example by remodeling the alveolar bone with bone replacement materials and reproducing the periodontal ligament interface between bone and root surface is desireable, from a clinical perspective, the success of bone grafts has not been predictable (Grant, Stern, and Listgarten, 1988, PERIODONTICS: IN THE TRADITION OF GOTTLIEB AND ORBAN, 6^{th} Ed., St. Louis: Mosby-Year Book, Inc. p. 860). One of the classic periodontal textbooks also states that “nothing can be said about the formation of new attachment” (Wolf and Rateitschak 2005, COLOR ATLAS OF PERIODONTOLOGY, New York: Thieme Medical Publishers), regardless of the multitude of bone attachment materials that have emerged during the recent decades. In fact, the same textbook emphasizes that the formation of new bone does not provide a periodontal “Holy Grail” and that the search for the ideal replacement material for alveolar bone continues (Wolf and Rateitschak, 2005, Id.). This reference finds that for non-inflamed, single-rooted teeth, current methods of bone replacement are often successful, while the treatment of complicated defects remains unpredictable at best (Wolf and Rateitschak, 2005, Id.).

Previous studies have succeeded in generating attachment of apatite implants (Sonoyama et al., 2006, PLos One 1: e79) but did not provide convincing evidence for periodontal ligament fiber attachment. Other studies have reported regeneration of a segment of the periodontium after fenestration using a cell sheet engineering strategy (Nakajima et al., 2008, J. Periodontal Res. 43: 681; Flores et al., 2008, J. Clin. Periodontol. 35: 1066). However, the origin of newly formed tissues has not been documented in these studies. There has been a first successful report on whole tooth organ replacement (Ikeda et al., 2009, Proc. Natl. Acad. Sci. USA 106: 1347527), a strategy that still faces significant challcnges for clinical application because of difficulties in generating sufficient numbers of suitable progenitor cells.

Thus, there remains in the art a need to better materials and methods for replacing teeth lost to periodontitis and other diseases and disorders resulting in tooth loss, particularly those materials and methods that result in replacement or reimplanted teeth that have a higher rate of stable, long-term implantation status.

### SUMMARY OF THE INVENTION

This invention provides reagents and methods for replacing teeth lost to periodontitis and other diseases and disorders resulting in tooth loss, and in particularly advantageous embodiments provides materials and methods that result in replacement or reimplanted teeth that have a higher rate of stable, long-term implantation status

In a first aspect, the invention provides an implantable tooth, comprising a natural or artificial animal tooth having a microporous tooth root surface, wherein said tooth root surface comprises a plurality of periodontal ligament progenitor cells coating all or a portion of the tooth root. In particular embodiments, the tooth is a natural tooth, especially a human tooth, either an autologous tooth or a heterologous tooth. In alternative embodiments, the tooth is an artificial tooth. In particular embodiments, the tooth comprises a periodontal ligament progenitor cell coating that further comprises one or a plurality of extracellular matrix proteins. wherein said proteins include but are not limited to periostin, F-actin, paxillin, tropoelastin, focal adhesion kinase, integrin α5, integrin β1, fibronectin, tenascin C, bone sialoprotein, fibronectin, a protein or peptide comprising the amino acid sequence arginine-glycine-aspartate (RGD), a collagen sponge or a nanopatterned hydrogel. In specific embodiments, said periodontal ligament progenitor cells are autologous periodontal ligament progenitor cells or, alternatively, heterologous periodontal ligament progenitor cells. In certain embodiments, the tooth root coating further comprises an angiogenesis-promoting compound.

In a second aspect, the invention provides kits for preparing an implantable tooth, comprising a plurality of containers, where in exemplary embodiments said kits comprise:
a) a first container comprising a solution for cleaning the tooth root surface;
b) a second container comprising a solution for enhancing the tooth root surface structure; and
c) a third container comprising protein components of an extracellular matrix scaffold capable of promoting growth of progenitor cells.
   Said kits of the invention also advantageously comprise instructions for using said kit for preparing the implantable tooth comprising a natural or artificial animal tooth having a microporous tooth root surface, wherein said tooth root surface comprises a plurality of periodontal ligament progenitor cells coating all or a portion of the tooth root. In particular embodiments, the kits of the invention comprise a solution for cleaning the tooth root surface that comprises a protease. In alternative embodiments, the kits of the invention comprise a solution for cleaning the tooth root surface that comprises an oxidizing agent. In particular embodiments, the kits of the invention comprise a solution for enhancing the tooth root surface structure that comprises citric acid or ethylenediamine tetraacetic acid (EDTA) or both. In alternative embodiments, said solution for cleaning the tooth root surface comprising a protease and said solution for enhancing the tooth root surface structure comprising citric acid or ethylenediamine tetraacetic acid (EDTA) or both are provided in a single solution. Said kits further advantageously comprise protein components of an extracellular matrix scaffold capable of promoting growth of progenitor cells that comprise periostin, F-actin, paxillin, tropoelastin, focal adhesion kinase, integrin α5, integrin β1, fibronectin, tenascin C, bone sialoprotein, fibronectin, a protein or peptide comprising the amino acid sequence arginine-glycine-aspartate (RGD), a collagen sponge or a nanopatterned hydrogel. Most particularly, each of the solutions comprising the kits of the invention is provided in a pharmaceutically acceptable solution. In certain embodiments, at least one container comprises dried components of said solution that are reconstituted using a pharmaceutically acceptable solvent, diluent or excipient. Particularly in said embodiments, the kits of the invention further comprise a container that contains a pharmaceutically acceptable solvent, diluent or excipient. In alternative advantageous embodiments, the kits of the invention comprise a container for collecting periodontal ligament progenitor cell-containing tissue. In further embodiments, the kits further comprise cell culture medium to harvest cells or tissues from the patient.

In another aspect, the invention provides methods for preparing an implantable tooth. In particular embodiments, said methods comprise the steps of cleaning a natural or artificial tooth root surface with a cleaning solution; enhancing the tooth root surface structure with an enhancing solution; applying to the tooth root surface protein components of an extracellular matrix scaffold capable of promoting growth of progenitor cells; and applying a coating to said prepared tooth root surface comprising periodontal ligament progenitor cells. In particular embodiments, the natural or artificial tooth root surface is cleaned with a cleaning solution comprising a protease. In alternative embodiments, the natural or artificial tooth root surface is cleaned with a cleaning solution comprising an oxidizing agent. In further particular embodiments, the natural or artificial tooth root surface is enhanced with a solution comprising citric acid, EDTA or both. In particularly advantageous embodiments, the steps of cleaning the tooth root surface and enhancing the tooth root surface structure are performed using a single colution comprising a protease and citric acid or ethylenediamine tetraacetic acid (EDTA) or both. In additional particular embodiments, the protein components of an extracellular matrix scaffold capable of promoting growth of progenitor cells that are applied to the tooth root surface comprise periostin, F-actin, paxillin, tropoelastin, focal adhesion kinase, integrin α5, integrin β1, fibronectin, tenascin C, bone sialoprotein, fibronectin, a protein or peptide comprising the amino acid sequence arginine-glycine-aspartate (RGD), a collagen sponge or a nanopatterned hydrogel. As provided herein, each of the solutions useful for treating the tooth root surface advantageously comprise a pharmaceutically acceptable solvent, diluent or excipient. Said periodontal ligament progenitor cells used in the practice of the methods of this invention are autologous or heterologous periodontal ligament progenitor cells.

Clinical benefits of alveolar bone engineering and tooth replacement using a combined materials/PDL progenitor approach using the reagents and methods set forth herein include then following. The ligament-anchored regenerated teeth as set forth herein eliminate the drilling required for dental implants, use less costly materials, reduce the need for alveolar ridge augmentation, and provide a greater resilience to occlusal stresses. In addition, without the drilling required for implant osseointegration, there is less or no danger for nerve injury or sinus perforation. The novel tissue engineering strategies for periodontal regeneration set forth herein will greatly benefit millions of Americans suffering from periodontal disease by making the procedure more economical, more reliable, less likely to fail and more likely to persist in the transplanted gums of individuals, and to encompass less trauma and bone- or tissue damage.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings.

FIGS. 1A through 1N show the effects of tooth root surface topography on initial attachment and spreading of mouse periodontal ligament progenitor cells (mPDLPs). As shown in FIGS. 1A and 1F, under the scanning electron microscope the natural root surface of a rat mandibular first molar exhibits an intricate, heavily grooved topography. The microporous topography of a physiological root surface had a significantly more pronounced surface relief than a nanostructured apatite surface (SEM photomicrograph shown in FIG. 1B) or a smoothened and polished root surface (SEM photomicrograph shown in FIG. 1D). Differences in pore sizes between surfaces are shown in FIG. 1H. Differences in surface topography resulted in significant changes in cell shape and attachment when apatite surfaces were seeded with mouse periodontal progenitor cells. On nano-patterned apatite, cells were flattened and spread out (FIG. 1C), on smoothened root surface apatite there was little or no attachment of cells (FIG. 1E), and on a microporous physiological root surface, cells demonstrated an elongated, fibroblast-like morphology (FIG. 1G). Compared to mPDLPs grown on smooth or nano-patterned apatite surfaces, mPDLPs grown on micro-porous root surface apatite were significantly more elongated (FIG. 1I). Western blot analysis demonstrated that the two early attachment focal adhesion proteins phospho-PAX Y31 and phospho-FAK Y397 were highly expressed on cells attached to physiologically structured, microporous root surfaces, while expression of these adhesion proteins was reduced in cells on nano-patterned surfaces and almost absent in cells cultured on smoothened apatite surfaces (FIG. 1J). Changes in gene expression as a result of surface topography were not unique to physiological roots but also occurred on smoothened or roughened apatite surfaces of identical chemical composition (FIGS. 1K through 1N).

FIGS. 2A through 2P show attachment and growth of mPDLPs on root surfaces of extracted teeth in vitro. FIG. 2A shows a denuded rat first maxillary molar prior to treatment with mPDLPs under light microscopy. Light microscopic images of mPDLPs attached to denuded first maxillary molars and cultured in vitro for 3 days prior to replantation in the tooth socket are shown in FIGS. 2B, 2C and 2D, showing particularly extension of fiber bundles and progenitor cells at the apical tip of the cultured implant (arrow, FIG. 2D). FIGS. 2E and 2f illustrate the distribution and morphology of mPDLPs seeded on rat first maxillary molars after 10 days of culture using scanning electron microscopy, particularly PDL-like fibrous outgrowths of parallel-aligned and elongated PDL-like cells at the apical end of the tooth root. Histological analysis of these outgrowths revealed fibrous attachment of mPDLPs on root surfaces after 10 days (FIG. 2H) compared to untreated controls (FIG. 2G). Western blot analysis (shown in FIG. 2I) and densitometric analysis (shown in FIG. 2J) were used to identify suibstantial changes in protein expression after periodontal progenitors were exposed to micro-patterned 3D surfaces (shown in FIG. 2I). Micropatterned 3D environments were created either by 3D cell culture in conjunction with micropatterned tooth root surfaces (center column: 3D) or after in vivo replantation for 8 weeks (right column: in vivo), and protein expression levels were compared to mPDLP expression levels in 2D culture without any microstructural challenge (left column: 2D). Densitometry revealed that for all six proteins investigated (β1 integrin, α5 integrin, fibronectin, Rho A, F-actin, and periostin), protein levels were higher after exposure to 3D micropatterned surfaces (FIGS. 2I and 2J). Integrin blockage (FIGS. 2M and 2N) resulted in a loss of actin fibers and polarization when compared to control mPDLPs cultured on fibronectin coated plates (FIGS. 2K and 2L), where rt=root, fib=fibers. A comparison between mPDLPs (FIG. 2O) and MC3T3 (FIG. 2P) cell attachment to microporous apatite surfaces demonstrated that while mPDLPs formed fibrous plaques of cells surrounding the apatite surface, MC3T3 cells did not form extended 3-D accumulations of cells between adjacent apatite blocks (compare, FIG. 2O and FIG. 2P).

FIGS. 3A through 3K illustrate that periodontal progenitor-driven new attachment of denuded teeth after 8 weeks of implantation in a tooth molar socket. Shown in vertical direction: FIGS. 3A, 3D and 3G are wild-type controls, FIGS. 3B, 3E and 3H are replanted mPDLP-treated molars, and FIGS. 3C, 3F and 3I are replanted molars that were not treated with progenitor cells prior to re-plantation. Shown in horizontal direction: FIGS. 3A, 3B and 3C are oral micrographs of rat upper right molar tooth rows; FIGS. 3D, 3E and 3F) are overview histological preparations documenting the root surface/ligament interface of an entire upper first molar tooth root; and FIGS. 3G, 3H and 3I are detailed histological micrographs of the root surface/periodontal ligament/alveolar bone interface in all three groups. As shown in FIGS. 3B, 3E and 3H, there was complete anatomical and histological integration of denuded and then mPDLP-treated rat first molars after eight weeks of re-implantation. Re-implanted rat molars that were not subjected to progenitor cell reattachment were either lost, partially exfoliated (FIG. 3C), or partially resorbed (FIGS. 3F and 3I). The replantation regime set forth herein resulted in the progenitor-based periodontal tissue engineering of the entire periodontium of a first maxillary molar (FIGS. 3J and 3K, which illustrate ultrathin ground sections in which the periodontium was stained with fuchsin. In FIG. 3J, the background outside of the fixed tooth organ was digitally removed and no other alterations were applied to the micrograph. Individual tissues are labeled for orientation. In these Figures, de=dentin, cem=cementum, pdl=periodontal ligament, ab=alveolar bone, res=resorption site, rt=root, m=first maxillary rat molar.

FIGS. 4A through 4H show the results of micro-computer tomography (mCT), scanning electron microscopic analysis and mechanical functional testing of progenitor cell treated re-implanted teeth versus replants without progenitor cell pre-treatment. FIGS. 4A and 4B show 3D-reconstructed mCT images of replanted rat molars that were either re-populated with periodontal progenitors (FIG. 4A) or left untreated (FIG. 4B). FIGS. 4C through 4F) are higher magnification mCT sections (FIGS. 4C and 4E) or scanning electron micrographs (FIGS. 4D and 4F) of a single first molar mesial root from progenitor-treated (FIGS. 4C and 4D) and untreated (FIGS. 4E and 4F) replanted teeth 16 weeks post replantation. Micrographs show optimum microanatomical integration of periodontal progenitor treated teeth (FIGS. 4A, 4C and 4D) in contrast to resorption, fracture, and partial ankylosis (FIGS. 4B, 4E and 4F) in untreated controls. Individual tissues were labeled for orientation purposes, wherein cr=crown, res=resorption, rt=root, ab=alveolar bone, de=dentin, ank=ankylosis, cem=cementum, pdl=periodonlal ligament. Levels of tooth displacement in response to mechanical loading are shown graphically in FIG. 4H, and were very similar between progenitor-treated replants and wild-type controls, while non-treated replants were either lost, loose, or ankylosed (respective percentages provided in FIG. 4G).

FIG. 5A through 5L show results of molecular characterization of the attachment apparatus of replanted teeth by molecular tracing, immunohistochemisty, and Western blotting. Fluorescent micrographs illustrated green fluorescence throughout the entire newly formed periodontium (FIGS. 5B, 5C and 5D and FIGS. 5F, 5G and 5H) while there was no fluorescence observed in non-treated replant teeth (FIGS. 5A and 5E). These results suggested that the newly formed periodontium was produced from green fluorescent protein (GFP)-labeled periodontal progenitor cells seeded on denuded root surfaces prior to implantation. FIGS. 5B, 5C and 5D are GFP images and FIGS. 5A and 5E and FIGS. 5F, 5G and 5H are overlays of the respective GFP and phase contrast images at a magnification of 5× (FIGS. 5A, 5B and 5F; bar=500 microns), 10× (FIGS. 5C and 5G; bar=250 microns) and 20× (FIGS. 5D, 5E and 5H; bar=125 microns). FIGS. 5I and 5J are photographs of immunohistostaining for periostin (FIG. 5I) and bone sialoprotein (BSP) (FIG. 5J) on paraffin sections of mPDLP seeded first maxillary molars that were replanted into the tooth socket and maintained in vivo for 8 wks. In FIG. 5I is illustrated intense localization of periostin along the newly synthesized PDL fibers, as is seen in native PDL. BSP expression was specifically localized at the apical root tip (FIG. 5J). FIG. 5K shows that similar expression levels for the extracellular matrix proteins periostin (PSTN), tenascin C (TNC), and tropoelastin (TEIn) between the progenitor cell treated replants and wild type controls as demonstrated by Western blot. In contrast, expression levels for these genes in untreated replants were either low (periostin, tenascin C) or non-detectable (tropoelastin). The sketch in FIG. 5L illustrates a simplified model of the effect of surface topography on periodontal progenitor cell shape and gene expression. In this schema, which will be understood to be illustrative and non-limiting, integrin surface receptors feed periodontal ligament cells with information about surrounding surfaces via the adhesome gene network. Integrin assembly and signal transduction cascades then affect intracellular machineries, including focal adhesion kinases and paxillins, which in turn regulate GTPases such as Rho to modulate actin microfilament polymerization and associated cytoskeletal changes. These changes cause periodontal ligament progenitors to elongate and stretch. In addition, intracellular integrin pathways also affect extracellular matrix gene expression, including collagens and periodontal matrix related proteins such as periostin. Thus, through the adhesome and associated integrin receptors, cell surfaces affect both periodontal cell shape and periodontal extracellular matrix gene expression, providing tissue-specific control over progenitor fate determination in the periodontal region.

Skilled artisans will appreciate that elements in the Figures are illustrated for simplicity and clarity and have not necessarily been drawn to scale. For example, the dimensions of some of the elements in the figures can be exaggerated relative to other elements to help improve understanding of the embodiment(s) of the present invention.

### DETAILED DESCRIPTION OF THE INVENTION

All publications, patents and patent applications cited herein are hereby expressly incorporated by reference for all purposes.

Methods well known to those skilled in the art can be used to construct expression vectors and recombinant bacterial cells according to this invention. These methods include in vitro recombinant DNA techniques, synthetic techniques, in vivo recombination techniques, and PCR techniques. See, for example, techniques as described in Maniatis et al., 1989, MOLECULAR CLONING: A LABORATORY MANUAL, Cold Spring Harbor Laboratory, New York; Ausubel et al., 1989, CURRENT PROTOCOLS IN MOLECULAR BIOLOGY, Greene Publishing Associates and Wiley Interscience, New York, and PCR Protocols: A Guide to Methods and Applications (Innis et al., 1990, Academic Press, San Diego, Calif.).

Before describing the present invention in detail, a number of terms will be defined. As used herein, the singular forms “a”, “an”, and “the” include plural referents unless the context clearly dictates otherwise. For example, reference to a “nucleic acid” means one or more nucleic acids.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The invention provides methods, reagents, kits and prepared cells for reimplantation into an animal particularly a human. As set forth herein, the relationship between cells and their surrounding matrices is a partnership of mutual reciprocity. As much as cells control the shape and structure of extracellular matrices by complex secretory processes, these scaffolds in turn exert profound control over gene expression profiles and lineage commitment of stem cell populations (Tan & Desai, 2003, Tissue Eng 9: 255). Through topographical cues, scaffolds affect essential parameters of cell behavior, including cell adhesion, morphology, viability, apoptosis, and motility (Norman & Desai, 2006, Ann. Biomed. Eng 334: 892). In recent years, the ability of natural extracellular matrices to aide whole organ regeneration has become increasingly important (Traphagen & Yelick, 2009, Regen. Med. 4: 747). While most natural extracellular matrix scaffolds rapidly disintegrate once removed from the body, the mineralized matrices of bones and teeth remain intact, often for hundreds or thousands of years after the surrounding organism is deceased. On a microenvironmental scale, the surface of these inorganic biological minerals retains a topographic impression of the cells and proteins that once contributed to their formation and contour, providing retrospective witness to the molecular interactions that helped to shape them.

Tooth root surface mineralized tissue topography is affected by the shape of the cells that form the root surface (cementoblasts) and by the insertion sites for the fibers that provide the mechanosensory link between the tooth root surface and the alveolar bone socket (Sharpey's fibers). The host tissue for Sharpey's fibers at the interface between root surface and alveolar bone is a fiber-rich connective tissue called the periodontal ligament (PDL). The PDL not only contains Sharpey's fibers but also provides a multifunctional extracellular matrix environment for mechanosensation, signal transduction, shock adsorption, and tissue remodeling. The periodontal extracellular matrix (ECM) is rich in collagen, fibronectin, tenascin, periostin, and other matrix molecules (Matsuura et al., 1995, J. Periodontol. 66: 579; Waddington & Embry, 2001, J. Orthod. 28: 281). Collagen I is the principle protein components of Sharpey's fibers (Embery, 1990, J. Orthod. 212: 77) and periostin is an indicator molecule of a functional PDL, as its expression changes dynamically in response to tension and compression (Rios et al., 2005, Molec. Cell. Biol. 25: 11131). Other periodontal glycoproteins such as fibronectin and tenascin provide RGD (Arginine-Glycine-Aspartate) motifs for cell adhesion (Rezania & Healy, 1999, Biotechnol. Prog. 15: 19). Among these, fibronectin is also a key molecule involved in integrin signaling, cell-extracellular matrix (ECM) attachment, cytoskeletal organization, and transduction of mechanical and chemical cues (Giancotti & Ruoslahti, 1999, Science 285: 1028). As much as the cells of the PDL control the deposition and remodeling of the ECM, the periodontal matrix also affects PDL cell behavior; and it is this reciprocity that provides the focus for the present application in tissue regeneration.

The invention as set forth herein utilizes the unique surface properties of mineralized tooth roots for tissue regeneration, by way of the inorganic memory of past cell matrix interactions. To illustrate the instructive capacity of tooth root cementum, the unique surface topography of denuded tooth roots has been exposed to instruct tissue-specific differentiation of periodontal progenitor cells. The results of experiments set forth herein showed that root cementum surface topographies induced highly specific integrin-mediated extracellular matrix signaling cascades which in turn restored periodontal progenitor populations into periodontal tissues genetically and functionally matching those of their natural counterparts. Moreover, the disclosed methods for replanting denuded tooth roots seeded with periodontal progenitors proved to be an effective strategy to fully regenerate lost tooth periodontia.

The term “autologous” as used herein refers to teeth removed from a donor and administered to a recipient, wherein the donor and recipient are the same individual.

The term “heterologous” as used herein refers to teeth removed from a donor and administered to a recipient, wherein the donor and recipient are different individuals.

As used herein the word “tooth” used in the singular also encompasses more than one tooth and encompasses natural mature teeth, retained teeth, part of one or more tooth (one root) and artificial teeth, including non osseo-integrated dental implants with or without a temporary crown. Any type of tooth can be used in the method of the present invention including molars, incisors, premolars and canines.

The periodontal progenitors useful as set forth herein are readily obtained from wisdom teeth, adjacent teeth, or even teeth extracted due to periodontal disease following treatment with inflammatory inhibitors.

The experimental results also provide a means for producing microtopographic surface modifications to solid implantable tooth replicas (instead of naturally occurring teeth), permitting formation of a physiological periodontium that anchors the implanted replica in an alveolar bone socket similar to a natural tooth. From a biological and practical point of view, this microtopography-instructed replantation strategy should prove more achievable that stem cell-based whole tooth regeneration approach while at the same time mimicking the tactile and biological properties of a physiological periodontium. The periodontal progenitors used as set forth herein can be readily obtained from wisdom teeth, adjacent teeth, or even teeth extracted due to periodontal disease following treatment with inflammatory inhibitors.

Kits are provided to facilitate performance of the inventive methods. In particular embodiments, kits of the invention provide a first container comprising a solution for cleaning the tooth root; a second container comprising a solution for enhancing the tooth root surface structure; a third container comprising protein components of an extracellular matrix scaffold capable of promoting growth of progenitor cells; and instructions for using said kit for preparing the implantable tooth comprising a natural or artificial animal tooth having a microporous tooth root surface, wherein said tooth root surface comprises a plurality of periodontal ligament progenitor cells coating all or a portion of the tooth root.

In particular embodiments, the solution comprising the first container for cleaning the tooth root comprises a protease, in particularly advantageous embodiments comprising collagenase/dispase. In alternative embodiments, said first container contains an oxidizing solution, including without limitation a 5-10% solution of sodioum hypochloride. In particular embodiments, the solution comprising the second container for enhancing the tooth root surface structure comprises citric acid (pH 1.0) or a 5% EDTA solution (pH 7.4). In particular embodiments, said protease is provided in a solution comprising citric acid or EDTA, provided that the resulting solution is capable of removing debris from said tooth surface and preparing the surface for the coating with protein components of the extracellular scaffold capable of promoting growth of progenitor cels. In particular embodiments, the protein components of an extracellular matrix scaffold capable of promoting growth of progenitor cells comprise periostin, F-actin, paxillin, tropoelastin, focal adhesion kinase, integrin α5, β1, fibronectin, tenascin C, bone sialoprotein, fibronectin, a protein or peptide comprising the amino acid sequence arginine-glycine-aspartate (RGD), a collagen sponge or a nanopatterned hydrogel. Each of said solutions advantageously comprises a physiologically acceptable diluent, buffer or solution. In additional embodiments, said container comprising protein components of an extracellular matrix scaffold capable of promoting growth of progenitor cells further comprise allogenic mesenchymal cells, wherein in such embodiments the kits are stored and shipped under conditions (for example, kept at ˜4° C. on ice) to preserve said cellular components. In these embodiments, the allogeneic mesenchymal cells are used in place of periodontal ligament progenonitor cells. In certain embodiments, one or more of said containers contain dried ingredients and the instructions include directions for reconstituting the solution or solution by adding a solvent, typically but not limited to water or a buffered solution thereof. In said embodiments, the kit can also comprise a physiologically acceptable solution for reconstituting said solutions. In certain embodiments, kits of the invention further comprise a collecting container or tube for collecting progenitor cell-comprising tissue.

The invention also provides methods for preparing an implantable tooth, comprising the steps of cleaning a natural or artificial tooth root surface with a cleaning solution; enhancing the tooth root surface structure with an enhancing solution; applying to the tooth root surface protein components of an extracellular matrix scaffold capable of promoting growth of progenitor cells; and applying a coating to said prepared tooth root surface comprising periodontal ligament progenitor cells.

In particular embodiments, the natural or artificial tooth root surface is cleaned with a cleaning solution comprising a protease, in particularly advantageous embodiments comprising collagenase/dispase. In alternative embodiments, said the natural or artificial tooth root surface is cleaned with a cleaning solution comprising an oxidizing solution, including without limitation a 5-10% solution of sodioum hypochloride, wherein treatment comprises contacting the tooth root surface with said oxidizing solution for about 5-10 minutes. In particular embodiments, the tooth root surface structure is enhanced with a solution comprising citric acid (pH 1.0) or 5% EDTA pH 7.4. In particular embodiments, said tooth root surface is treated with said protease is provided in a solution comprising citric acid or EDTA, provided that the resulting solution is capable of removing debris from said tooth surface and preparing the surface for the coating with protein components of the extracellular scaffold capable of promoting growth of progenitor cels. In particular embodiments, the protein components of an extracellular matrix scaffold capable of promoting growth of progenitor cells that is applied to the tooth root compises periostin, F-actin, paxillin, tropoelastin, focal adhesion kinase, integrin α5, integrin β1, fibronectin, tenascin C, bone sialoprotein, fibronectin, a protein or peptide comprising the amino acid sequence arginine-glycine-aspartate (RGD), a collagen sponge or a nanopatterned hydrogel. Each of said solutions advantageously comprises a physiologically acceptable diluent, buffer or solution.

### EXAMPLES

The Examples that follow are illustrative of specific embodiments of the invention, and various uses thereof. They are set forth for explanatory purposes only, and are not to be taken as limiting the invention.

### Materials and Methods

mPDLP Cell Culture and GFP Labeling

First mandibular molars of CD-I mice were extracted and periodontal ligament (PDL) attached to root surfaces was scraped off. Tissue scrapings were then digested in collagenase/dispase (3 mg/mL, obtained from Roche Applied Science, Indianapolis, Ind.) with gentle rotation at 37° C. for 1 h to release singles cells that were further cultured to give rise to colonies. Primary cells released in this manner were washed twice with phosphate-buffered saline (PBS) and passed through a 70 mm strainer to obtain single cell suspensions. Cells were then plated at a density of ˜1×10⁵ cells/100 mm tissue culture dish in Dulbecco's modified Eagle's medium (DMEM) supplemented with 10% fetal bovine serum (FBS) and 1% antibiotic/antimycotic mixture. Cell clones (colonies) with the highest ability to differentiate into osteogenic and adipogenic lineages (data not shown) were used as progenitor cells in subsequent experiments. For stable expression of GFP, mPDLPs were transduced with pBabe-eGFP retroviral vector kindly gifted by Nissim Hay as described previously (Luan et al., 2006, Stem Cells Dev. 15: 595).

SEM Analysis of mPDLPs Cultured on Nano-HA, Microporous Root and Smoothened Root Surfaces

mPDLPs were seeded and cultured for 6 hrs on 3 mm³ sized blocks of nanohydroxyapatite blocks (nHAB), physiological tooth root surface of rat maxillary first molars or on artificially smoothened root surface created by polishing. Alternately, mPDLPs were seeded on physiological tooth roots and either cultured for 3 days and then replanted back in the corresponding tooth socket for 16 weeks or left in culture in vitro for 10 days. Non cell-seeded tooth roots served as the controls in both sets of experiments. After the stipulated time points, samples were fixed, dried, splutter coated with gold-palladium and viewed using a 3500-S Hitachi SEM.

### Characterization of Surface Topography and Cell Attachment and Spreading on Implant Surfaces

Surface topography parameters such as amount and size of pores on nano-HA, microporous tooth root and smoothened root surface were calculated by measuring pore sizes (mean diameter) on SEM micrographs of these surfaces using the NIH imaging software (ImageJ), and values were reported as percentages of pore sizes in the range of 5-100 nm on nano-HA and 50-400 microns on physiological microporous root surface. Cell spreading on nano-HA, microporous root surface and smooth root surface after 6 hrs of incubation was measured in terms of cell elongation, which was calculated as a ratio of cell length to width.

### First Maxillary Molar Extraction and Subsequent Replantation

All animal procedures were approved by and complied with institutional guidelines provided by the Institutional and Animal Care and Use Committee (IACUC). Athymic nude rats (approx. 250 gm, body weight) were fed powdered rat chow containing 0.4% beta aminopropionitrile for 2 days to reduce the tensile strength of collagen molecules and to facilitate gentle tooth extraction with minimum damage to the surrounding periodontal tissues (Wikesjo et al., 1988, J. Clin. Periodontol. 15: 73). Under anesthesia with ketamine (100 mg/kg)/xylazine (5 mg/kg), first maxillary molars were extracted using forceps, and subjected to collagenase/dispase treatment to digest the attached PDL fibers and cells. The denuded teeth were then treated with 5% EDTA solution pH 7.4 for 10 mins (surface demineralization and exposure of organic matrix), washed thoroughly with distilled water and fixed in 70% ethanol overnight. Tooth samples were then washed thoroughly in DNase/RNase free water for 4 hours with 3 changes to fresh water and then air dried in a sterile hood to prepare for cell seeding. Immediately after extraction, the extraction sites were cleaned with surgical dental burs, plugged with a collagen sponge and allowed to heal until replantation. Extraction sites were reopened after 4 days of healing and cleaned with a dental bur under constant irrigation to facilitate easy re-entry of the extracted maxillary molars. Molars used for replantation were either seeded with mPDLPs and cultured for 3 days or left untreated. Once the tooth was replanted back in its socket, it was stabilized with the adjacent second molar using a thin coat of glass ionomer dental restorative just high enough to maintain the physiologic occlusion with the corresponding mandibular molar.

### Masson's Trichrome Staining

mPDLPs were seeded on EDTA-etched physiologic first molars and either cultured in vitro for 3 days prior to replantation into the corresponding healing tooth socket for 8 weeks or left in culture for 10 days. Non-cell seeded molars served as the controls. At the end of the stipulated time point for in vitro and in vivo studies the implants were harvested, fixed, decalcified, and processed for paraffin embedding. Subsequently, sections (5 microns in thickness) were stained with Masson's trichrome stain (Sigma Chemical Co., St. Louis, Mo.) as follows.

mPDLPs were seeded on EDTA-etched physiologic first molars by suspension in DMEM at a density of 10⁶ cells/mL and subjected to end-to-end rotation for 2 hrs at 37° C. This treatment was followed by an in vitro culture for 3 days prior to replantation into the corresponding healing tooth socket for 8 weeks or longer. Non-cell seeded molars served as controls. At the end of the stipulated time point for in vitro and in vivo studies the implants were harvested and fixed in 10% neutral buffered formalin for 4 days, decalcified in 10% phosphate buffered EDTA (pH 7.4) for 4 weeks for in vivo replants and 10 days for in vitro constructs and dehydrated in a series of alcohol changes, cleared by xylene and embedded in paraffin. Subsequently, 5 micron thick sections were cut and placed on poly-lysine coated slides. Sections were then stained with Masson's trichrome stain (Sigma) according to the manufacturer's instructions, resulting in labeled cell nuclei in black, collagen fibers in blue and cytoplasm in red.

### Micro-CT Analysis

To visualize mineralized tissues, maxillary tissue blocks with replanted teeth with or without mPDLP treatment were analyzed using micro computed tomography (micro-CT). For this purpose, 3D X-ray CT images were acquired by means of an Xradia MicroXCT 400 (Xradia, Concord, Calif.). Briefly, a 1024 by 1024 image matrix size over a 5.12 mm field of view was used to create an isotropic voxel size of 5 microns. A total of 1024 slices were acquired for each tooth section. No filtering processes were applied after the scan and reconstruction. During the scans. 30 KeV 6 watt x-ray beams were generated to image the samples; 5 seconds exposure time was used for each of the hundreds of projection images with 0.25 degree step angle.

### Immunohistochemistry and Fluorescence

Rat maxillae with mPDLP-seeded replanted teeth and non cell-seeded replanted teeth 8 weeks after replantation in the tooth socket were harvested, fixed, decalcified, and processed for paraffin embedding and sectioning. Alternatively, mPDLPs were seeded on fibronectin coated cover slips with integrin α5β1 blocked or unblocked and cultured for 12 hrs in vitro. Effects on actin stress fiber formation was observed using rhodamine conjugated phalloidin. For immunohistochemistry, slides were deparaffinized and tissues were rehydrated. Immunoreactions were performed as described in Luan et al. (2007, J. Histochem. Cytochem. 55: 127, incorporated herein by reference in its entirety), using monoclonal primary antibody for periostin (Abcam, Cambridge, Mass.), BSP (Abcam) and GFP on both the mPDLP-seeded experimental group and the non-cell seeded control groups. Sections were incubated with primary antibody at room temperature for 1 hour at a dilution of 1:500 in PBS. Sections were washed and incubated for 10 min with appropriate anti-mouse IgG or anti-rabbit IgG secondary antibody and further incubated with streptavidin-enzyme conjugate. Signals for immunoreactions were detected using AEC substrate-chromogen mixture (color substrate), counterstained with hematoxylin, and slides were mounted using GVA mount. For negative controls, the primary antibody was replaced with a similar amount of PBS.

### Mechanical Testing of Functional Tooth Re-Attachment

After 16-24 weeks of replantation, mPDLPs seeded and non-cell seeded control groups were harvested with the teeth intact in the maxilla and subjected to mechanical testing using a Wagner force dial gauge (Wagner instruments Inc., Cos Cob, Conn.). The rat head was held firmly in place using a metal clamp. A metal probe was designed to apply translational force to the crowns of the replanted teeth (both mPDLP seeded experimental group and non cell seeded controls) and the amount of displacement was then captured using a digital camera. Tooth crown surfaces were subjected to both 10N and 15N translational force, with the exception of loosely attached teeth from the non cell-treated reimplant group, in which case on 1N was applied. At each force level, three measurements were obtained and the amount of displacement was recorded in each case. The images were captured before and after the application of force and the net displacement of the first maxillary molar was calculated as a difference between the position of a reference point on the first molar in relationship to the image midline before force application and the position of the same reference point related to the image midline after application of the force.

### Western Blot Analysis

mPDLPs were cultured on nano-HA, artificially smoothened tooth root, natural tooth root surface, polished apatite or roughened apatite for 6 hr to observe initial cell attachment. Alternatively, mPDLPs were seeded on denuded tooth roots for 3 days prior to replantation in the tooth socket or cultured in two dimensions (2D) on tissue culture plastic. Progenitor cell-seeded teeth and non-cell seeded controls were replanted in the tooth socket for 8 weeks. At the end of each experimental time point, samples were harvested and washed with PBS. The constructs were then homogenized in sodium dodecylsulfate-polyacrylamide gel electrophoresis (SDS-PAGE) sample buffer and proteins extracted as described (Luan et al., 2006, ibid., incorporated by reference in its entirety herein). Identical amounts of protein extracts from all experimental and control groups were separated on a 4-20% SDS-PAGE gel and transferred to PVDF membrane in a semi-dry blotting apparatus containing transfer buffer (25 mM Tris, 40 mM glycine, 10% methanol) for 45 minutes at 75 mA. The PVDF membrane was then blocked with 5% BSA for 1hour at room temperature and the blot was incubated with 1:1000 dilution of periostin, tropoelastin, tenascin-C, fibronectin, Rho A (1:2000), F-actin (1:700), integrin α5 (1:1500) and β1 (1:1500), and GAPDH (1:2500) (all from Abcam, Cambridge, Mass.) antibodies for 2 hour, washed with TBST 3 times and incubated with 1:2500 dilution of horse radish peroxidase (HRP)-conjugated anti-rabbit or anti-mouse secondary antibody respectively (Zymed, South San Francisco, Calif.) for 1 hour, and further washed 3 times with TBST. HRP detection was performed using a chemiluminescent substrate (Supersignal West Pico Chemiluminescent Substrate, Pierce Protein Research Products, Rockford, Ill.).

### Statistical Analysis

All experiments were performed in triplicate unless stated otherwise. Final values were reported as means +/−standard deviation. Data were analyzed using Student's t-test and p-values less than 0.005 in each comparison were considered statistically significant.

### Example 1

### Natural Tooth Rool Surfaces are Microporous

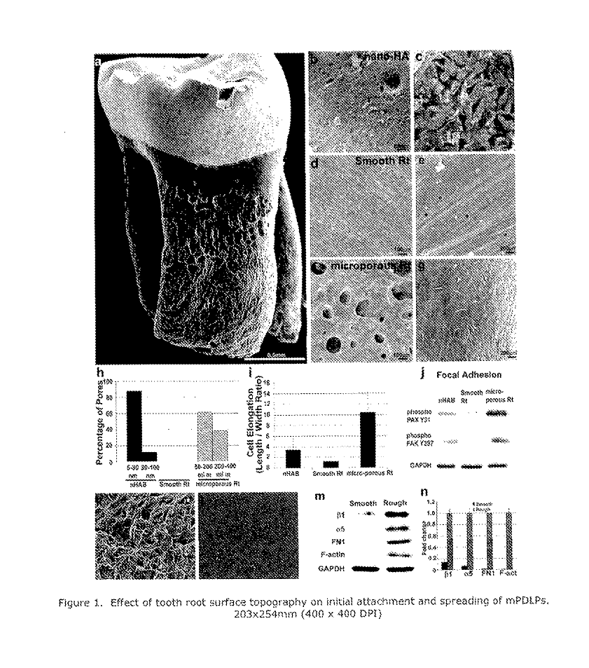

Fully developed rodent molar tooth root features an intriguing surface structure of microporosities, ridges, and impressions (shown by SEM in FIG. IA). Further analysis of a native rat molar root surface compared with nano-patterned hydroxyapatite (nHAB) (the latter shown by SEM in FIG. IB) and an artificially smoothened root surface (shown in FIG. ID) revealed pores having a diameter of between 50-400 microns on native root surfaces, while artificially smoothened root surfaces did not contain measurable pores and nano-patterned apatite contained pores from 5-100 nm in diameter (comparison of pore sizes visualized for each source as set forth above using SEM and shown in FIGS. IB, 1D, 1F and 1H). In order to test the effect of surface pattern on cell behavior, mouse PDL progenitor cells (mPDLPs) were cultured as described above on the aforementioned apatite surfaces for six hours and cell dimensions were evaluated thereafter. Following culture, cell length-to-width ratios were found to be 3.56 on nano-hydroxyapatite surfaces, 1.05 on smoothened root surfaces, and 10.28 on naturally porous native root surfaces (comparisons shown in FIGS. 1C, 1E, 1J and 1L). In comparison, cells on naturally porous native root surface were 9.8-fold more elongated than those on their smoothened counterparts, while cells on nano-patterned surfaces were less elongated (2.32-fold) than those residing on their micro-porous counterparts (p<0.005 for each comparison). These findings indicate that the extracellular matrix is capable of facilitating cell polarization of these cells (see Hynes, 2009, Science 326: 1216). These effects of apatite surface microtopography on cell behavior are also consistent with results reported for other model systems, mostly osteoblasts and implant studies, all indicating that roughened microtopographies improve mineral deposition, adhesion, migration, proliferation, and osteogenic differentiation (see Buser et al., 1991, J. Biomed. Mater. Res. 25: 889; Boyan et al., 2002, Calcif. Tissue Int. 71: 519; Popat et al., 2006, J. Orthop. Res. 24: 619; Biggs et al., 2008, J. R. Soc. Interface 5: 1231), but this is the first instance where effects of tooth surface topography on progenitor cells has been found.

### Example 2

### Apatite Surface Morphology Alters Cell Shape and Early Response Gene Expression

Based on the observed relationship between surface topography and cell adhesion behavior as shown in Example 1, it was likely that expression of early focal adhesion mediators was affected by surface properties. In order to demonstrate this effect of surface topography on cell adhesion machinery in periodontal progenitors, mPDLP cells were incubated on different apatite surfaces for six hours. In a first set of experiments, the effect of surface parameters on two early focal adhesion proteins involved in mediating cellextracellular matrix contacts, paxillin (PAX) and focal adhesion kinase (FAK) (Berrier et al., 2008, Biochem. Biophys. Res. Commun. 368: 62) was assessed. Compared to PDL progenitor cells cultured on nano-patterned hydroxyapatite, mPDLPs on microporous natural root surfaces featured an 8.8-fold increase in phospho-PAX Y31 and a 6.2-fold increase in phospho-FAK Y397. In contrast, phospho-PAX Y31 on smoothened root surfaces was 8.3-fold reduced and phospho-FAK Y397 was not detectable (as shown in FIG. 1J). In order to assess to what extent the effects of surface properties on gene expressiou were solely due to surface properties, cells were incubated on rough and smooth apatite surfaces derived from an identical block of mineral. Surface roughness was modified either by polishing or by sandblasting in conjunction with steam cleaning (shown in FIGS. 1K and 1L). After 12 hr of culture on these two surfaces, cells maintained a spherical shape on smooth surfaces in contrast to elongated spindle shaped morphology on rough surfaces. In order to determine the effect of surface roughness on cell attachment mediators, changes in fibronectin and related integrin cell surface mediators were assessed. Smooth apatite surfaces demonstrated a significant reduction in β1 and α5 integrin cell surface mediators (7.1-fold for β1 and 14.3-foled for α5) in tandem with similarly dramatic reduction in the fibronectin extracellular matrix protein (67.8-fold reduction) and the cytofilament F-Actin (101.3-fold) as shown by Western blot analysis (these results obtained as set forth above and shown in FIGS. 1M and 1N) (p<0.005 in each comparison). These studies demonstrated how modifications in apatite surface topography alone resulted in powerful alterations in mPDLP cell shape and in the expression of key early molecules involved PDL progenitor cell adhesion to a substrate.

### Example 3

### De-Cellularized Root Surfaces Induce Periodontal Progenitor Polarization via Integrin Signaling Pathways

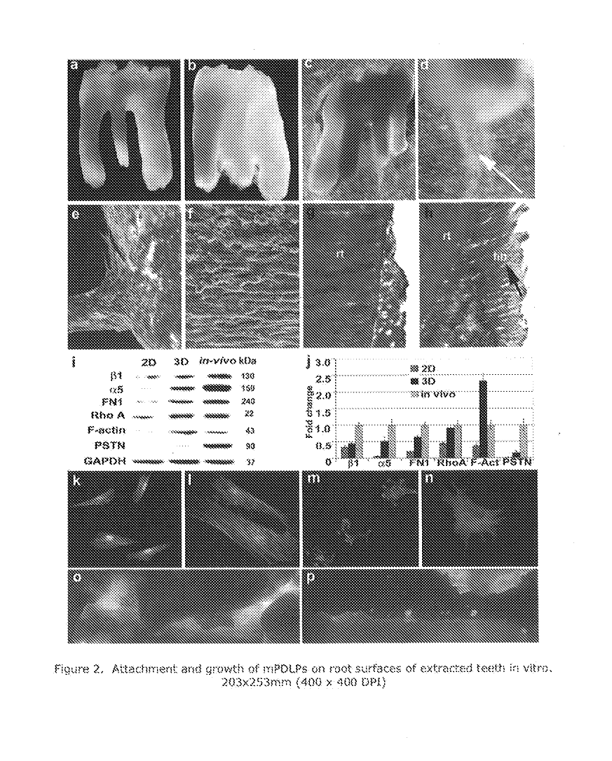

Based on the conduciveness of natural tooth root surfaces to trigger cellular elongation and expression of molecular adhesion mediators as demonstrated above, it was determine that de-cellularized and denuded surfaces of extracted teeth provide a suitable microenvironment to stimulate attachment and tissue-specific growth of periodontal progenitor cell populations. Periodontal ligament progenitor cells (mPDLPs) were grown on denuded tooth roots in vitro for either four or ten days, and newly formed tissues were evaluated using scanning electron microscopy and histology as described above. After four days, mPDLPs formed a dense population of cells surrounding the incubated tooth root (shownh by light microscopy in FIG. 2A through 2D). After ten days of incubation, the root surface was immersed into a dense lawn of cells and fibers (shown in FIGS. 2E, 2F and 2H). Histological investigation performed as described aboce showed cells and parallel oriented fibers perpendicular to the root surface (FIG. 2H) on denuded and then mPDLP-seeded first molars compared to an absence of fiber bundles on untreated surfaces (FIG. 2G). This striking effect of root surface haptotactic signals on periodontal ligament stretching and perpendicular fiber orientation resembles previous observations related to integrin-mediated cell polarization in other systems (see Nishiya et al., 2005, Nat. Cell. Biol. 7: 343; Huttenlocher, 2005, Nat. Cell. Biol. 7: 336).

On a molecular level, this extraordinary ability of cells to adjust their cytoskeletal organization, and hence their shape and motility, to minute changes in their immediate surroundings, was accomplished by integrin-based adhesion complexes, which are tightly associated with the actin cytoskeleton (Geiger et al., 2009, Nat. Rev. Mol. Cell. Biol. 10: 21). In order to investigate the effects of integrin cell surface receptors on cell shape and cytoskeletal organization, and because fibronectin was known to be one of the major periodontal ECM proteins, two major fibronectin-associated integrin subunits α5 and β1 (Giancotti et al., 1990, Cell 60: 849) were assayed. mPDLPs exposed to regular 2D culture dishes (2D), 3D root surface environments in vitro (3D) (i.e., cells were grown in vitro on denuded root surfaces for 3 days prior to replantation), and mPDLPs that were replanted in vivo for 8 weeks (in vivo) (shown in FIGS. 2I and 2J) were compared to determine the effects of root surface topography on integrin-related signaling networks. Compared to tooth-cell constructs implanted in vivo, α5 and β1 integrin expression was reduced to 50% in 3D cultures, while in 2D cultures expression levels were once more reduced to 34% (β1) and 6% (α5) (FIGS. 2I and 2J). Surprisingly, F-actin expression in 3D culture was found to be 2.32-fold higher than comparable expression levels in vivo while expression levels in regular 2D culture dishes was reduced to 37%. Rho-A was expressed at a similar level in 3D culture and in in vivo reimplants, and was reduced to 44% in 2D cultures compared to in vivo constructs. Periostin expression in 2D and 3D cultures was severely reduced to 2% and 15%, respectively, compared to in vivo reimplants (FIGS. 2I and 2J) (p<0.005 in each comparison). Together, these data indicated that exposure to topographically patterned 3D root surfaces greatly enhanced protein levels of integrin α5 and β1, fibronectin, Rho A, and actin microfilaments (F-actin), both in vitro and in viva A possible exception to this trend was the periodontal extracellular matrix protein periostin, which was uniquely elevated in implanted periodontia, while exposure to cultured root surfaces (FIGS. 2I and 2J) resulted only in a marginal increase in expression levels. This tissue-specific dependency of periostin on periodontal environments may be due to neighboring tissues or due to the effect of mechanical forces and stimuli that continuously affect the periodontium. Together, these data established that the mineralized tooth cementum surface contains much of the instructive information required to trigger integrin-based focal adhesion events and subsequent cell polarization in periodontal progenitors.

These studies subjecting mPDLPs to three-dimensional root surfaces or periodontal in vivo environments indicated that periodontal tooth root surface topography affected many molecules that are involved in classical integrin signaling cascades, particularly α5 and β1 integrins. To test the extent to which these molecules were involved in this phenomenon, α5 and β1 integrins were blocked using specific antibodies, and as a consequence periodontal progenitors lost their polarized orientation, developed processes, and assumed a polygonal overall shape (shown in FIGS. 2M and 2N). In addition, there was a significant loss of actin microfilament related stress fibers (also shown in FIGS. 2M and 2N). These results further established a pivotal role of integrins in the maintenance of PDL progenitor cell shape and polarization. mPDLP cells cultured on fibronectin-coated plates without integrin blockage showed intense stress fiber formation and a cell length-to-width ratios of 5.6 that were significantly higher than in cells in which integrins α5 and β1 were blocked and had a cell length to width ratio of only 1.15 (shown in FIG. 2K through 2N).

This behavior was further assessed by comparing two different types of progenitors, mPDLPs and MC3T3 cells, to determine whether formation of attachment tissues on apatite surfaces depended on surface structure alone. As shown in FIGS. 2O and 2P, mPDLPs formed fibrous plaques of cells surrounding the apatite surface and MC3T3 cells did not. These results showed that formation of fibrous, cellular tissues on apatite surface was not only dependent on surface topography but also on progenitor cell type. Together, these findings supported the conclusion that integrin-based signaling cascades were involved in mPDLP polarization and gene expression changes that mediated the effects of tooth root surface properties on periodontal tissue differentiation and extracellular matrix fiber formation.

### Example 4

### Successful Replantation of Denuded Tooth Scaffolds Populated with Periodontal Progenitors

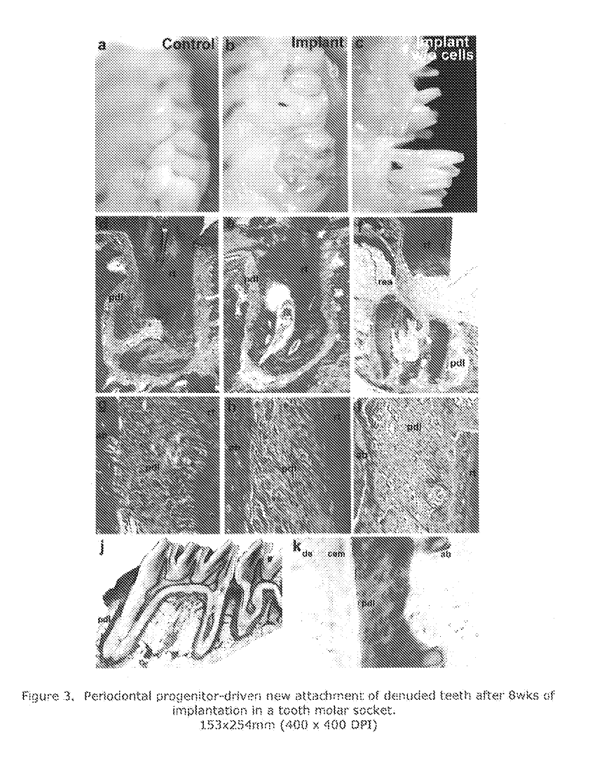

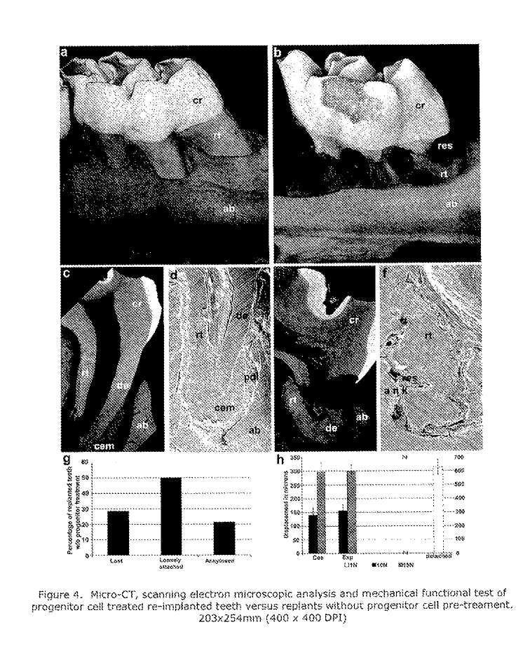

Faithful reproduction of periodontal fiber formation and orientation on in vitro cultured, denuded root surfaces suggested that mPDLP populated, extracted and denuded tooth matrices provide suitable templates for the replantation of extracted teeth. In order to test this hypothesis, first maxillary rat molars were extracted, cleaned, and re-populated with periodontal progenitors as set forth above. In tandem, rat molar extraction wounds were covered with a collagen sponge and allowed to heal for four days. After four days, extracted teeth repopulated with mPDLPs were re-planted into extraction sockets, stabilized with glass-ionomer, and kept within the rat's mouth for two or four months. After two months, mPDLP-treated and replanted teeth were entirely integrated into the rat molar tooth row (as shown in FIG. 3B) and resembled wild-type control teeth (shown FIG. 3A). In contrast, only a portion of the non-mPDLP treated tooth replants remained in the jaw (shown in FIG. 3C). Detailed analysis using histology (after 8 weeks), micro-CT, and scanning electron microscopy (after 16 weeks, each techique performed as described above) revealed that the periodontal apparatus of the replanted tooth molar root consisted of cementum, alveolar bone, and a physiological periodontal ligament (shown in FIGS. 3E, 3H, 3J and 3K and in FIGS. 4A, 4C and 4D), resembling the periodontal ligament of control molar roots (shown for comparison in FIGS. 3D and 3G). Ground sections of progenitor-treated and reimplanted molar teeth demonstrated that this procedure resulted in the new formation of the entire periodontal ligament of a multirooted tooth with physiological new fiber attachment on two molar tooth roots (FIG. 3J). In contrast, molar teeth that were reimplanted without prior incubation in periodontal progenitor cell lawns were either lost entirely, partially exfoliated, ankylosed, or extensively resorbed (see, for comparison, FIGS. 3C, 3F and 3I and FIGS. 4B, 4E and 4F). Among the 14 cell-free reimplants, 28.5% of the molars were lost, 21.4% were ankylosed, and about 50% were loosely attached (FIG. 4G). Eight weeks after replantation surgery, all of the 14 molar tooth reimplants treated with progenitor cells were firmly attached to their corresponding tooth socket.

Throughout their lifetime, tooth periodontia are constantly exposed to a number of biomechanical forces, most frequently as a result of their contact with antagonistic teeth (Nies & Ro, 2004, Brain Res. Brain Res. Protoc. 12: 180). These forces result in physiological displacement of teeth and subsequent return to a resting position. In order to test whether replanted teeth would withstand displacement following application of a physiological bite force, replanted and control teeth were subjected to a displacement test. For this study, forces of 10N and 15N were applied to the crown surface and displacement was measured using high magnification digital morphometry as described above. Control teeth and progenitor treated replants showed similar displacement patterns with 141±23 microns and 156±19 microns displacement after application of 10N and 297±34 microns and 300±26 microns displacement after application of 15N, respectively (results shown in FIG. 4H). In contrast, application of 10N or 15N forces to loosely attached teeth in the group that were not pre-treated with progenitor cells resulted in unlimited displacement thereof (FIG. 4H). A comparison with 1N displacement force resulted in an effective displacement of 626±31 microns of loosely attached teeth (FIG. 4H) (p<0.005 in each comparison). Thus, also from a mechanical perspective, engineered periodontia as produced herein closely resembled their natural counterparts.

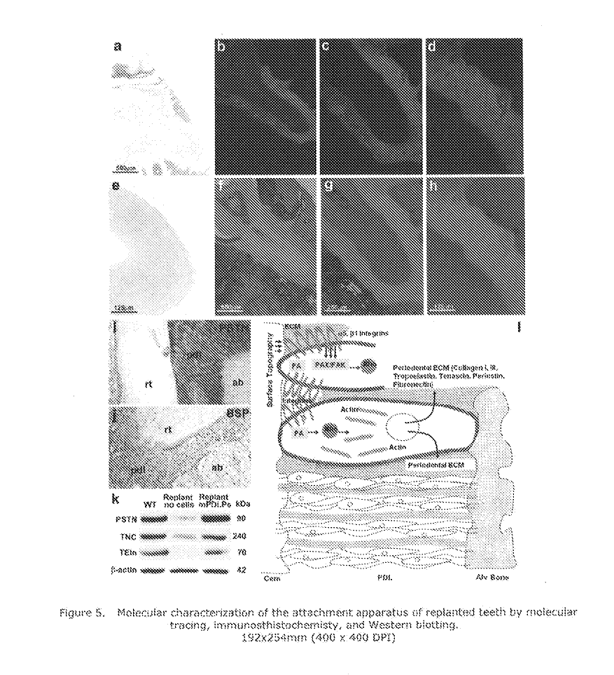

In order to determine whether newly formed periodontia were generated by progenitor cells used to populate tooth roots prior to replantation or whether these newly formed tissues had been regenerated through invasion of potent cells from surrounding tissues, progenitor cells were GFP-labeled as described above prior to incubation with denuded tooth roots. The data obtained from these experiments demonstrated that GFP-positive mPDLP cells had regenerated the periodontium and formed a firm attachment between the root dentin of the replanted tooth and the alveolar bone at 8 wks post implantation (shown in FIGS. 5B, 5C, 5D and FIGS. 5F, 5G and 5H). In contrast, there was a distinct lack of GFP expression in the non cell-seeded tooth replants and a thin space between the tooth root and fibrous tissue that lacked attachment (FIGS. 5A and 5E).

In addition, whether newly formed periodontia expressed characteristic periodontal extracellular matrix proteins such as periostin, tenascin C, tropoeiastin and BSP was investigated; these results are shown in FIG. 5I though 5K. When evaluated by immunohistochemistry and Western blot analysis as described above, similar protein levels for periostin (130% of WT), tenascin C (92% of WT), and tropoelastin (84% of WT) were found in wild-type (WT) controls and progenitor-treated replants, while expression levels for these proteins in replants that were not incubated with periodontal progenitors were greatly inhibited (10% for periostin, 21% for tenascin C, and no detectable expression for tropoeiastin) (FIG. 5I though 5K), confirming that newly formed periodontia resembled control periodontia.

Having described the invention in detail and by reference to specific embodiments thereof, it will be apparent that modifications and variations are possible without departing from the scope of the invention defined in the appended claims. More specifically, although some aspects of the present invention are identified herein as particularly advantageous, it is contemplated that the present invention is not necessarily limited to these particular aspects of the invention.

What is claimed is:

1. An implantable tooth, comprising a natural or artificial animal tooth having a microporous tooth root surface, wherein said tooth root surface comprises a plurality of periodontal ligament progenitor cells coating all or a portion of the tooth root.

2. The implantable tooth of claim 1, wherein the tooth is a natural tooth.

3. The implantable tooth of claim 2, wherein the tooth is a human tooth.

4. The implantable tooth of claim 1, wherein the tooth is an artificial tooth.

5. The implantable tooth of claim 1, wherein the periodontal ligament progenitor cell coating further comprised one or a plurality of extracellular matrix proteins.

6. The implantable tooth of claim 5, wherein the extracellular matrix protein is periostin, F-actin, paxillin, tropoelastin, focal adhesion kinase, integrin α5, integrin β1, fibronectin, tenascin C, bone sialoprotein, fibronectin, a protein or peptide comprising the amino acid sequence arginine-glycine-aspartate (RGD), a collagen sponge or a nanopatterned hydrogel.

7. The implantable tooth of claim 2 that is an autologous tooth.

8. The implantable tooth of claim 2 that is a heterologous tooth.

9. The implantable tooth of claim 1 wherein the periodontal ligament progenitor cells are autologous periodontal ligament progenitor cells.

10. The implantable tooth of claim 1 wherein the periodontal ligament progenitor cells are heterologous periodontal ligament progenitor cells.

11. The implantable tooth of claim 1, wherein the tooth root coating further comprises an angiogenesis-promoting compound.

12. A kit for preparing an implantable tooth, comprising
d) a first container comprising a solution for cleaning the tooth root surface;
e) a second container comprising a solution for enhancing the tooth root surface structure;
f) a third container comprising protein components of an extracellular matrix scaffold capable of promoting growth of progenitor cells; and
g) instructions for using said kit for preparing the implantable tooth comprising a natural or artificial animal tooth having a microporous tooth root surface, wherein said tooth root surface comprises a plurality of periodontal ligament progenitor cells coating all or a portion of the tooth root.

13. A kit according to claim 12, wherein said solution for cleaning the tooth root surface comprises a protease.

14. A kit according to claim 12, wherein said solution for cleaning the toth root surface comprises an oxidizing agent.

15. A kit according to claim 12, wherein said solution for enhancing the tooth root surface structure comprises citric acid or ethylenediamine tetraacetic acid (EDTA) or both.

16. A kit according to claim 12, wherein said solution for cleaning the tooth root surface comprising a protease and said solution for enhancing the tooth root surface structure comprising citric acid or ethylenediamine tetraacetic acid (EDTA) or both are provided in a single solution.

17. A kit according to claim 12, wherein the protein components of an extracellular matrix scaffold capable of promoting growth of progenitor cells comprise periostin, F-actin, paxillin, tropoelastin, focal adhesion kinase, integrin α5, integrin β1, fibronectin, tenascin C, bone sialoprotein, fibronectin, a protein or peptide comprising the amino acid sequence arginine-glycine-aspartate (RGD), a collagen sponge or a nanopatterned hydrogel.

18. A kit according to claim 12, wherein each of said solutions is provided in a pharmaceutically acceptable solution.

19. A kit according to claim 12, wherein at least one container comprises dried components of said solution that are reconstituted using a pharmaceutically acceptable solvent, diluent or excipient.

20. A kit according to claim 12, further comprising a container that contains a pharmaceutically acceptable solvent, diluent or excipient.

21. A method for preparing an implantable tooth, comprising the steps of
a) cleaning a natural or artificial tooth root surface with a cleaning solution;
b) enhancing the tooth root surface structure with an enhancing solution;
c) applying to the tooth root surface protein components of an extracellular matrix scaffold capable of promoting growth of progenitor cells; and
d) applying a coating to said prepared tooth root surface comprising periodontal ligament progenitor cells.

22. The method of claim 21, wherein the natural or artificial tooth root surface is cleaned with a cleaning solution comprising a protease.

23. The method of claim 21, wherein the natural or artificial tooth root surface is cleaned with a cleaning solution comprising an oxidizing agent.

24. The method of claim 21, wherein the natural or artificial tooth root surface is enhanced with a solution comprising citric acid, EDTA or both.

25. The method of claim 21, wherein the protein components of an extracellular matrix scaffold capable of promoting growth of progenitor cells comprise periostin, F-actin, paxillin, tropoelastin, focal adhesion kinase, integrin α5, integrin β1, fibronectin, tenascin C, bone sialoprotein, fibronectin, a protein or peptide comprising the amino acid sequence arginine-glycine-aspartate (RGD), a collagen sponge or a nanopatterned hydrogel.

26. The method of claim 21, wherein cleaning the tooth root surface and said enhancing the tooth root surface structure are performed using a single colution comprising a protease and citric acid or ethylenediamine tetraacetic acid (EDTA) or both.

27. The method of claim 21, wherein the tooth root surface is treated with solutions that each comprise a pharmaceutically acceptable solvent, diluent or excipient.

28. The method of claim 21, wherein the periodontal ligament progenitor cells are autologous periodontal ligament progenitor cells.

29. The method of claim 21, wherein the periodontal ligament progenitor cells are heterologous periodontal ligament progenitor cells.
